(19) United States
(12) Patent Application Publication
(10) Pub. No.: US 2011/0191147 A1
(43) Pub. Date: Aug. 4, 2011

(54) Methods And Systems For Internet-Based Network Shareholder Communication, Voting, And The Creation Of Regulatory Compliant Shareholder Proposals

(76) Inventor: Argus I. Cunningham, Naples (IT)

(21) Appl. No.: 13/019,038

(22) Filed: Feb. 1, 2011

Related U.S. Application Data
(60) Provisional application No. 61/300,572, filed on Feb. 2, 2010.
(60) Provisional application No. 61/315,281, filed on Mar. 18, 2010.

(51) Int. Cl. G06Q 99/00

(52) U.S. Cl. 705/12; 705/317; 705/1.1

(57) ABSTRACT

Systems, methods and software applications for conducting network shareholder voting actions and shareholder proposals by utilizing a server data base. A web site enables any member share holder in a network of shareholder members to initiate a vote and allow all network members of the same stock, the option to vote for, against, or to abstain from the said subject voting process. All members of the network are updated about the progress of voting results as they occur. The system also provides means for the origination of a regulatory compliant corporate proposal while providing regulatory compliance information and a time keeping and notification function to assist in compliance procedures.

### CROSS REFERENCE TO RELATED APPLICATIONS

This application relates to, claims priority from and the benefit of co-pending U.S. provisional patent application entitled “Internet based Share Holder Action Process,” Ser. No. 61/300,572, filed Feb. 2, 2010; and U.S. provisional patent application entitled “Process for Internet Based Network Share Holder Communication and Action,” Ser. No. 61/315,281, filed Mar. 18, 2010, the disclosures of which provisional applications are incorporated herein by reference as if set forth in full.

### TECHNICAL FIELD

This disclosure relates generally to business methods and technology to implement the methods and more particularly to a process and system for internet-based electronic shareholder organization, centralization, and collaboration utilizing an internet accessible network of known stake holders and server-hosted shareholder voting software applications.

### BACKGROUND

The present disclosure relates to a process and system for internet based electronic shareholder organization, centralization, and collaboration utilizing an internet accessible network of known stake holders and server-hosted shareholder voting software applications. This allows a modern system and software capability for shareholders to conduct functions advantageous to corporate governance processes.

Public Corporations are largely administered by officers who are appointed by a board of directors who are elected by shareholders. The number of individual shares and the votes associated with them may number in the billions. This large fragmented voting base partially assembles at annual share holders' meeting where voting commences. This meeting is often held in a physical location where available members may attend.

At these meetings, directors are nominated and elected through a voting process, as are other issues proposed. Members not physically available may vote by proxy (mail) if they so desire. Historically, for the majority of shareholders, this meeting will be the only time many of them will interact with their fellow shareholders. During this time period, limited opportunities exist to discuss the matters at vote with one's fellow shareholders.

On the Internet, many forums have appeared that cater to stock shareholders where shareholder initiated actions are sometimes discussed. These various boards and websites have decreased voter fragmentation but are largely limited to discussion only. The current proliferations of shareholder focused websites are focused primarily on investment decision making, not shareholder actions.

If a shareholder of a company finds fault with actions of the directors or officers, current methods of recourse are often disorganized. The ability to bring up the said matter, to fellow shareholders is difficult because the voting base is fragmented among many websites, mutual funds, and asset managers. How does one bring a topic to the attention of others and effect change? The challenge lies in organizing the potential billions of shareholders into one forum where events can be discussed and tools exist for mass organization and decision making.

The current utilization of proxy methods while holding annual shareholder meetings may become the “old” way of doing business. These annual meetings may become the official execution of policy decisions made by active shareholders in multiple meetings and votes held electronically in the time periods leading up to the corporately scheduled meeting. Among the objectives of the present system are to facilitate shareholders communication, provide software tools to facilitate shareholder initiated actions, enable shareholder voting on actions and to obtain a majority decision. The present system allows shareholder meetings to occur continuously, which provides greater opportunities for prudent shareholder input into corporate governance.

The present system is advantageous because shareholders are often held to blame for many corporate maladies. They are not to blame for their action, but for their inaction. As corporations have grown larger in scope and number, the ability for shareholders to organize and enact good governorship has become more difficult. Although shareholders are deemed responsible for corporate leadership through their voting decisions, infrequent meetings and lack of collaboration regarding fellow shareholders inhibit the efficiency of this process. Current internet based networking platforms have not addressed this factor.

A need exists, therefore, for a forum where shareholders can be verified, where share holder specific topics can be discussed, and where matters may be brought to an electronic vote displayed in real time, with results accessible by all subscribed and authorized members. The revolutionary capability for networking and communication introduced by the internet makes this now possible. From time to time herein, the methods, software applications and system components may be referred to collectively as the “system” as will be evident from the context.

### SUMMARY

The method and technology of the present disclosure allows efficient shareholder action to be initiated, coordinated, and successfully carried out. It enables a shareholder to propose and initiate shareholder actions and proposals. As the initiation process is implemented, all registered network members, and, in particular, network shareholders of the company that is the subject of the action, are notified of the action initiation.

All eligible members will be given the electronic option of vote for, against, or to abstain from the action. As voting takes place, the outcome will be continually updated and displayed until one of two results occur. Result “one”, is that a successful majority is obtained and the action is successfully passed. Result “two”, is that a majority is not obtained in the given time frame and the action is not passed.

The time frame requirement is to disallow multiple actions over extended periods of time. Throughout the voting process, all eligible shareholders will be notified electronically, when certain voting benchmarks are achieved.

Eligible shareholders will be informed of their percentage voting power by the mathematical processes allowing any member to easily recognizing their level of influence in the matter to be voted upon.

Eligible shareholders are informed of the network sum voting power by the mathematical processes allowing any member to easily recognize the level of influence of the entire network, in the matter to be voted upon.

Eligible shareholders have the ability to vote for, against, or to abstain from shareholder action.

Although these voting actions are simulated and non-binding, verified voters conducting real discussions and voting on real issues is the desired outcome. Actual voting at official shareholder meetings may likely match the simulated voting outcomes present in the system.

Eligible shareholders will have the ability to easily draft a regulatory compliant shareholder proposal with compliance measures built into the software processes.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagrammatic illustration of an exemplary embodiment of an online member dashboard user interface of a system of the present disclosure.

FIG. 2 is a diagrammatic illustration of an exemplary embodiment of an online company profile user interface of a system of the present disclosure.

FIG. 3 is a diagrammatic illustration of an exemplary embodiment of an online member action instructions page of a system of the present disclosure.

FIG. 4 is a diagrammatic illustration of an exemplary embodiment of an online member action input form user interface of a system of the present disclosure.

FIG. 5 is a diagrammatic illustration of an exemplary embodiment of an online member action completion notification of a system of the present disclosure.

FIG. 6 is a diagrammatic illustration of an exemplary embodiment of an online member action status page of a system of the present disclosure.

FIG. 7 is a diagrammatic illustration of an alternative embodiment of an online company profile user interface of a system of the present disclosure.

FIG. 8 is a diagrammatic illustration of the online member dashboard user interface of FIG. 1, illustrating the events functions with action updates of a system of the present disclosure.

FIG. 9 is a diagrammatic illustration of an exemplary embodiment of an online company proposal user interface of a system of the present disclosure.

FIG. 10 is a diagrammatic illustration of an online company proposal submission user interface of the system of FIG. 9.

FIG. 11 is a diagrammatic illustration of an online company proposal submission review and confirmation user interface of the system of the FIG. 9.

FIG. 12 is a diagrammatic illustration of an online company proposal submission completion notification of the system of FIG. 9.

FIG. 13 is a diagrammatic illustration of an exemplary embodiment of an online company profile user interface of a system of the present disclosure, illustrating a company gate for network shareholders of a company to review and vote on proposals.

FIG. 14 is a diagrammatic illustration of an exemplary embodiment of an online member dashboard user interface, illustrating the events functions with proposal updates of a system of the present disclosure.

FIG. 15 is a diagrammatic illustration of an exemplary embodiment of an online member forum user interface of a system of the present disclosure.

FIG. 16 is a process flow diagram of an exemplary embodiment of a method of the present disclosure.

### DETAILED DESCRIPTION

The following explanation is a stepwise description of a method by which a shareholder may utilize and benefit by the present system. System components and software applications to enable the method are also described.

System components include without limitation at least one server hosting a website on the World Wide Web, also referred to as the Internet. The server provides a processor and a computer readable memory unit coupled to the processor. The memory unit contains program code configured to be executed by the processor to implement a method for conducting a shareholder action among shareholders of a company in an online network. A shareholder joins the network by filling out an electronic membership application online which is then verified by processes well known in the art, including data aggregation and retrieved streaming data services.

Once network membership in the network is granted, a profile sheet is created where some personal information aggregated from online resources is automatically filled in and other information maybe provided by the member. For example, the new member is presented with the opportunity to enter some personal information. The acronym “SHNM” as utilized herein refers to the shareholder and network member.

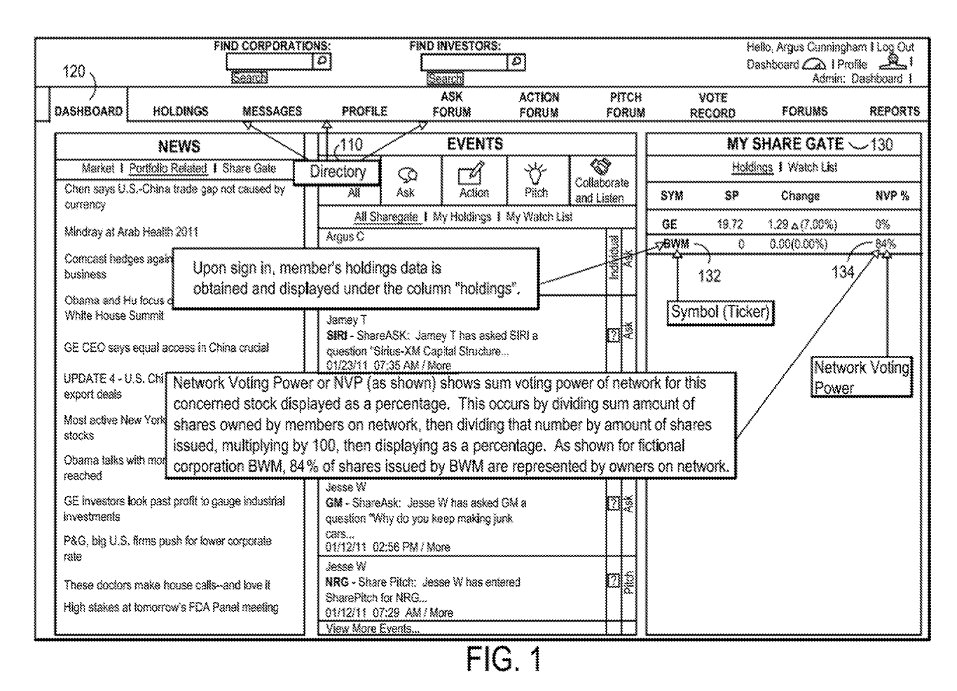

Referring now to FIG. 1, FIG. 1 is a diagrammatic illustration of an exemplary embodiment of an online member dashboard user interface of a system of the present disclosure. The member's holdings information is obtained, by download from a trusted source, for example, and visible on the member dashboard page 120. The concerned shareholder and now network member now has access to the communication and collaboration tools of the network.

By way of example, say SHNM has two thousand shares of fictional company BWM. The outstanding number of shares issued by BWM is 10 million. In a preferred embodiment, the outstanding share data comes from a trusted external data service from which corporate information is obtained.

The website provides a “Holdings” page in directory 110 which displays that SHNM has a voting power score of “0.02” (not shown). The voting power is determined by taking the number of shares owner (e.g., 2000), dividing by the number of outstanding shares (e.g., 10 million), then multiplying by 100 and displaying the end product as a numerical representation. SHNM's voting power is 0.02 concerning company BWM. Additionally, the dashboard 120 displays the cumulative voting power of all BWM shareholders in the network under My Share Gate 130, which displays SHNM holdings and watch list by company symbol (SYM) 132, price (SP), Price Change (Change) and the Network Voting Power (NVP) 134. In this example, the network members hold 84% of the outstanding stock in BWM.

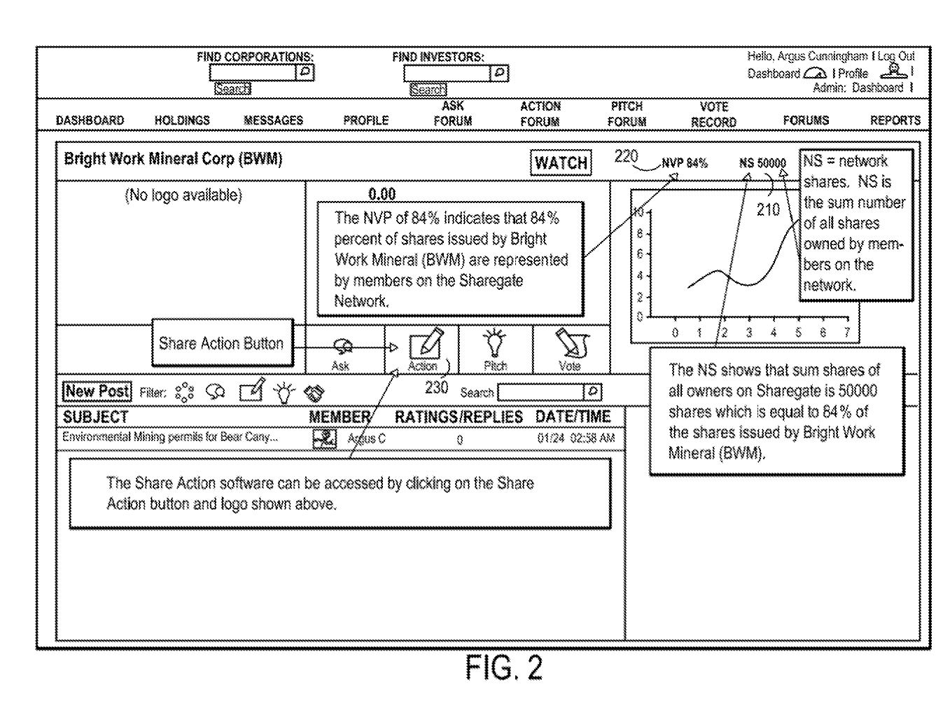

FIG. 2 is a diagrammatic illustration of an exemplary embodiment of an online company profile user interface of a system of the present disclosure. In FIG. 2, the profile 210 for a particular company may be viewed. The profile displays the Network Power (NP) 220 for the company, which is percentage of the total outstanding shares in the company that are held by the sum of all Network members. In the example of FIG. 2, the NVP of BWM is 84%. The profile also shows, among other data, the total number of shares (NS) 222 in the company held by the sum of network members, as well as the current value (NSV) 224 of the network shares. To initiate a shareholder action, SHNM activates the “Action” application 230.

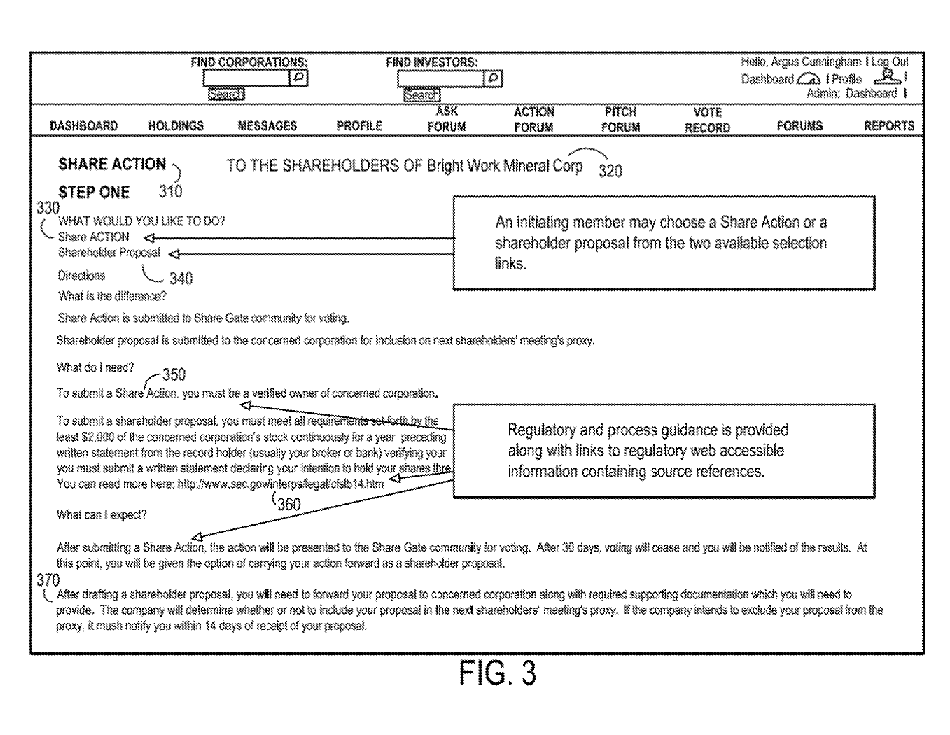

FIG. 3 is a diagrammatic illustration of an exemplary embodiment of an online member action instructions page 350 of a system of the present disclosure. The instruction page of FIG. 3 may be optionally displayed, particularly for first time Action initiators, and takes the form of an FAQ in specific embodiments. The nature of the Action is shown as a “Share Action” 310 and it is indicated that the Action is directed to the shareholders of company GE 320. Under step One, SHNM may select the type of action in initiate, a share ACTION 330 or Shareholder Proposal 340. Instructions 350 are provided to submit a Share Action, with more information provided with a hypertext link 360. The consequences of submitting a Share Action are explained 370.

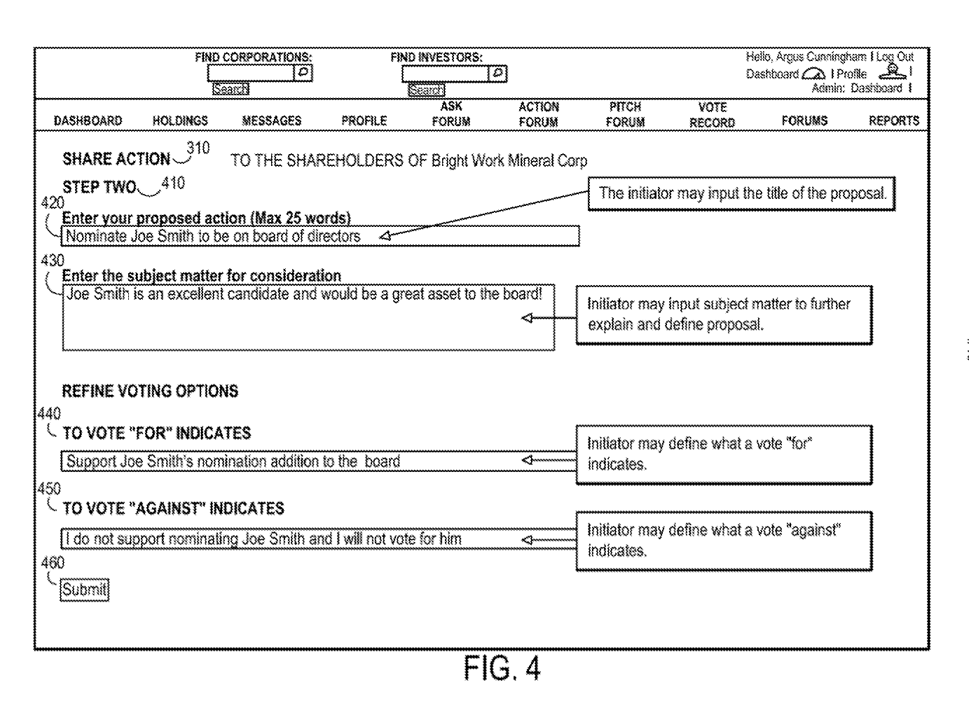

FIG. 4 is a diagrammatic illustration of an exemplary embodiment of an online member action input form user interface of a system of the present disclosure. In Step two 410, SHNM inputs 420 the proposed Action and supporting data 430 to support the claim including the reasons, outcomes desired, and supporting information in the form of hyperlinks, references and/or attachments. SHNM indicates what a vote “FOR” means 440 and what a vote “AGAINST” means 450. When the Action is compete, SHNM submits the proposal to fellow Network member who have BWM shares by clicking “Submit” virtual button 460 of the user interface.

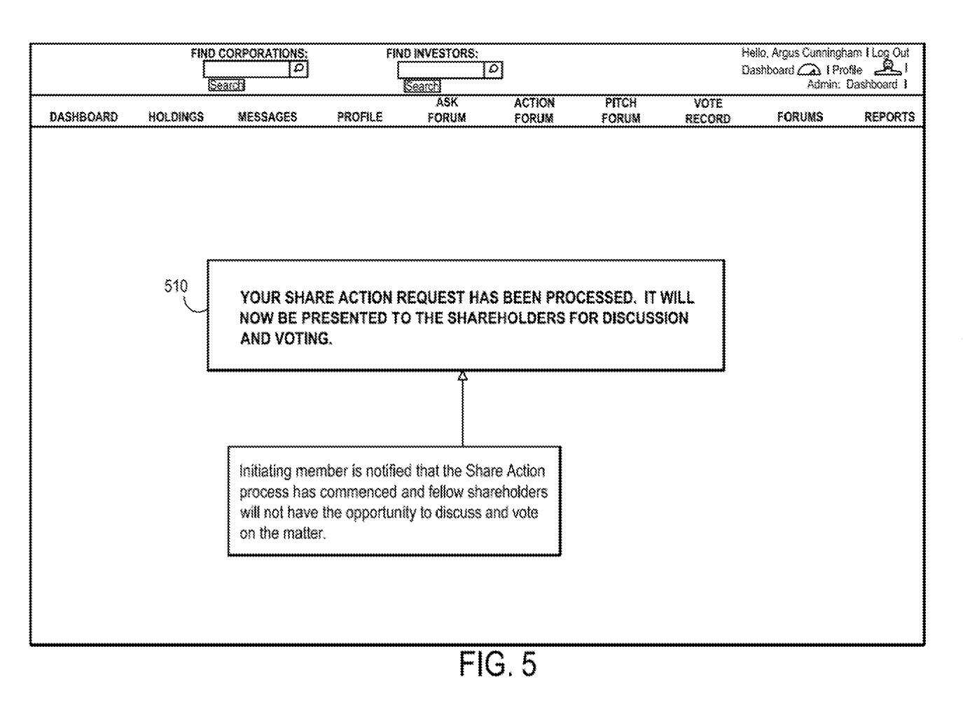

FIG. 5 is a diagrammatic illustration of an exemplary embodiment of an online member action completion notification of a system of the present disclosure. Notification 510 is displayed upon successful submission of the Action.

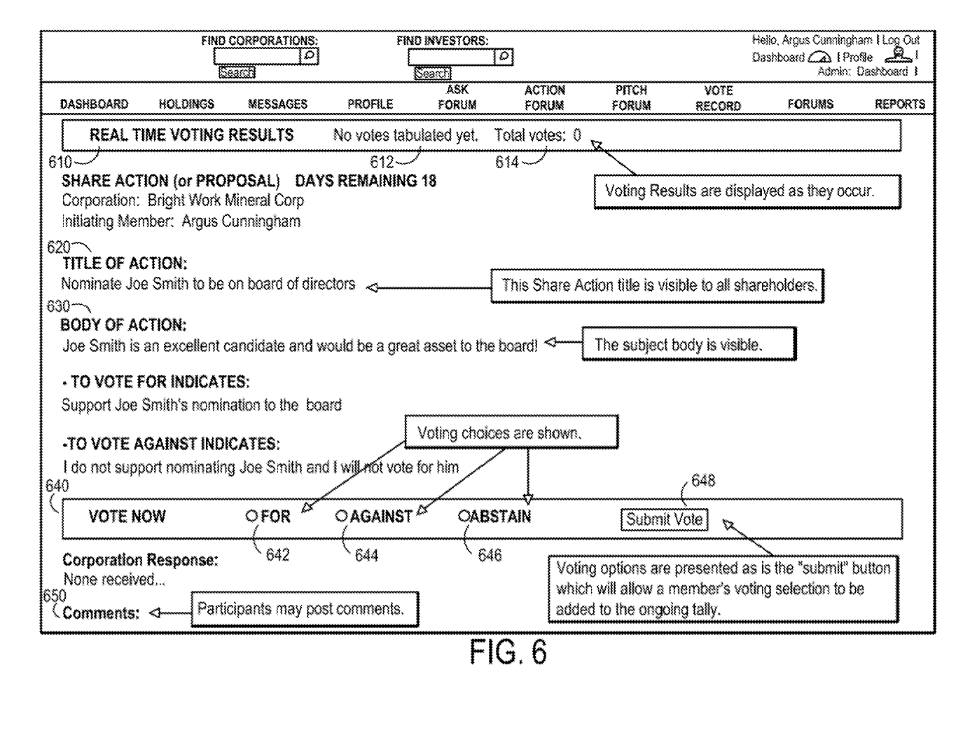

FIG. 6 is a diagrammatic illustration of an exemplary embodiment of an online member action status page of a system of the present disclosure. Real time voting results for the Action are displayed in bar 610. In the exemplary embodiment of FIG. 6, results show that no votes have been tabulated 612 and the total votes 614 is zero.

The status page summarizes the Action with the title 620 and the body 630 as well as explanations of vote “FOR” and “AGAINST” as discussed above. Voting mechanism 640 is provided with “For” 642 “AGAINST” 644 “ABSTAIN” 646 and “Submit Vote” 648. In addition a comment window 650 is provided. The time of sequence commencement is recorded. A time table of previously determined limits is established.

Network owners of the company are notified of the process initiation by email or by their profile page when viewed. All network shareholder owners of the subject company are presented with the option to vote for, against, or to abstain. Owners of the company who desire to participate enter their responses. Voting results are tabulated then displayed using the number of votes divided by outstanding shares then multiplied by 100. This will give all the network member information regarding what percentages of available voters are voting for what options.

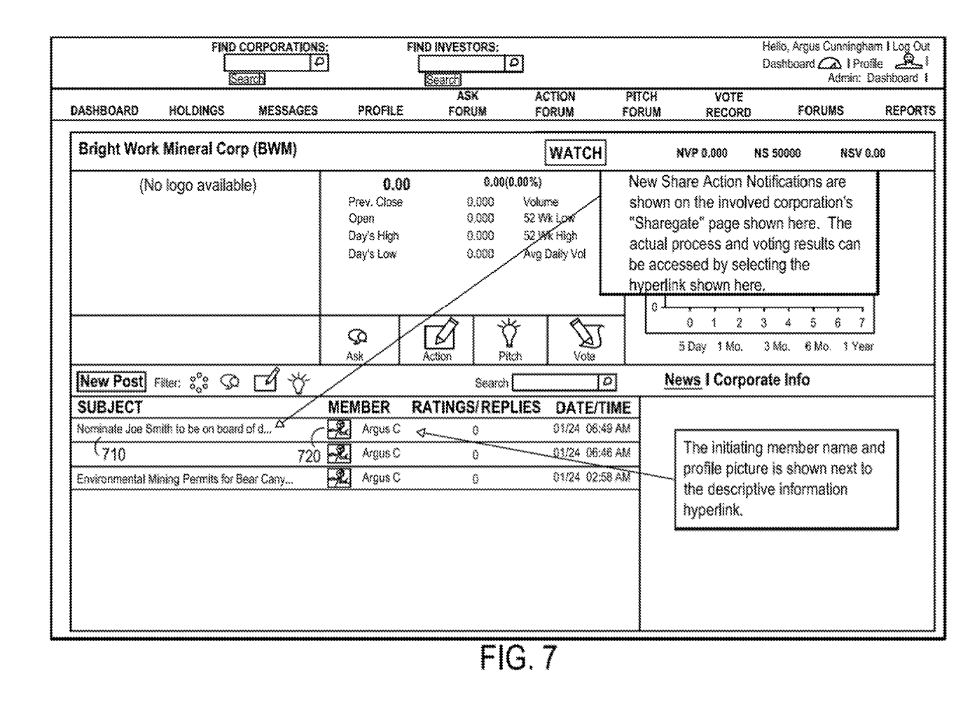

FIG. 7 is a diagrammatic illustration of an alternative embodiment of an online company profile user interface of a system of the present disclosure. SHNM wished to be notified by email of all shareholder actions initiated by shareholders of the company. SHNM is notified, for example by email or an update to a profile page 710, anytime a fellow network owner of the company initiates an action 720. All network owners of the company are notified of the action by email or an update on their profile pages viewable on login.

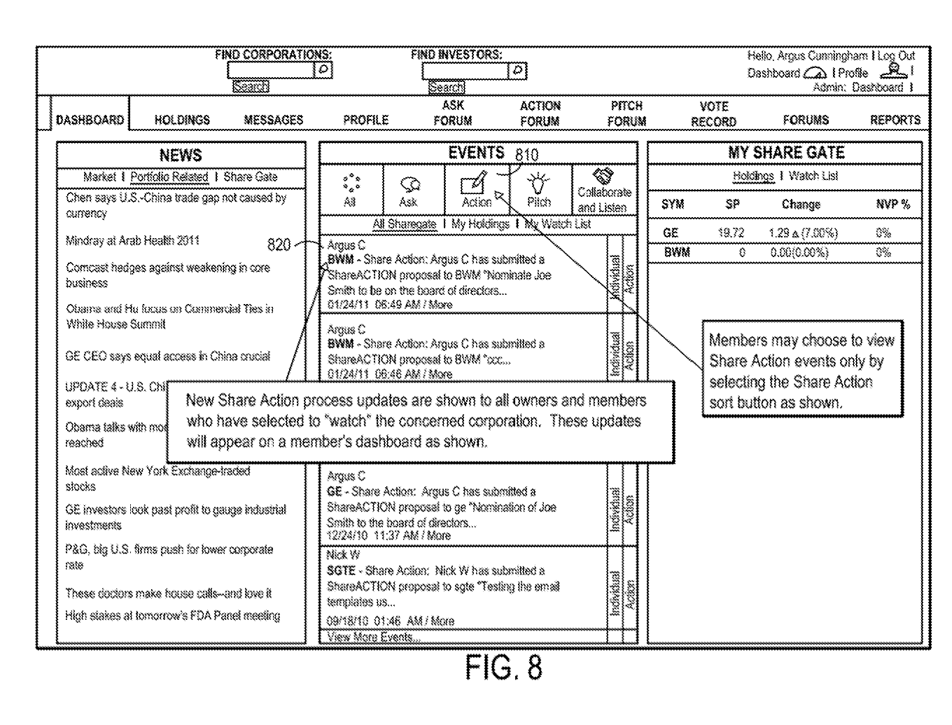

FIG. 8 is a diagrammatic illustration of the online member dashboard user interface of FIG. 1, illustrating the events functions with action updates of a system of the present disclosure. Network members may choose to view only Share Action by selecting the “Action” virtual button 810. New Share Action activity updates are shown to all owners and members who have elected to “watch” the company that is the subject of the Action. The updates appear on the member dashboard.

SHNM wishes to draft a regulatory compliant shareholder proposal and accesses the Share Action 310 Shareholder Proposal function 340.

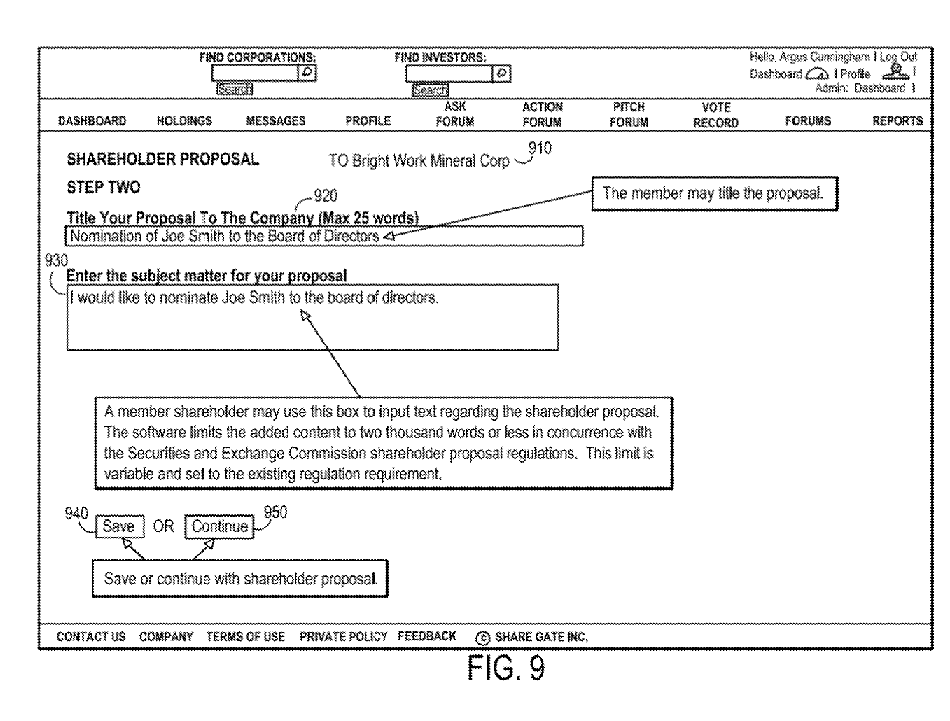

FIG. 9 is a diagrammatic illustration of an exemplary embodiment of an online company proposal user interface of a system of the present disclosure. The Share Action software allows the member to title, contribute data, attached hyperlinked references and receive regulatory guidance during the assembly of the shareholder proposal 910.

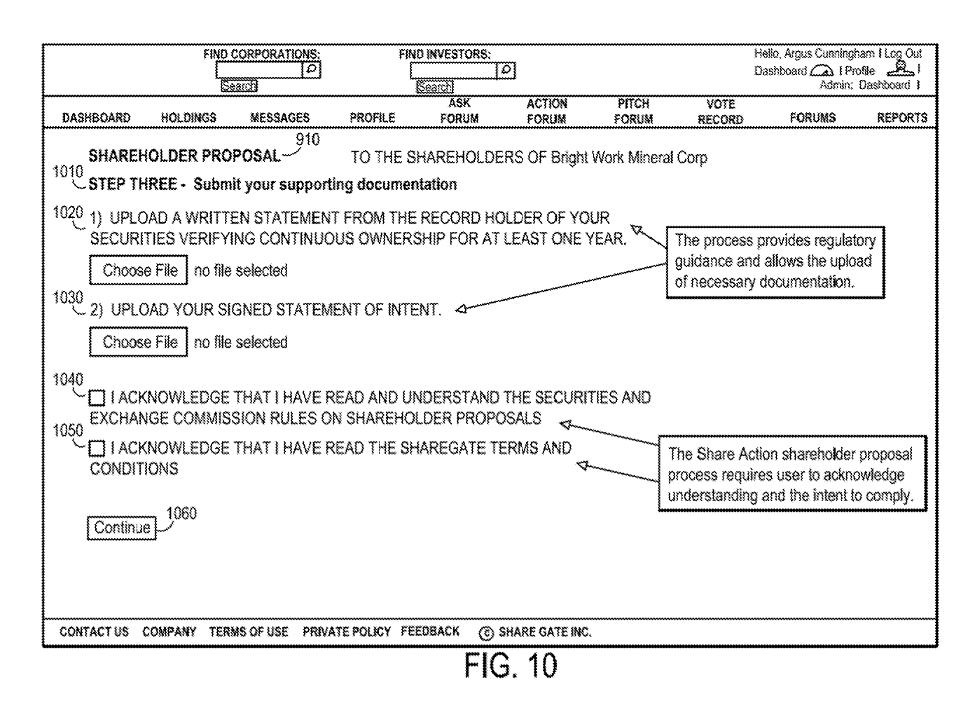

Similar to the shareholder action submission process of FIG. 4, above, a shareholder proposal to the company is given a title 920, a body 930 which provides a text window for comments, hyper links and so on, and explanation of “For” 940 and “AGAINST” 950. However, rather than a ‘Submit” virtual button 460, the proposal process provides a “Save” function 960 and a “Continue” function 970, so that the data of FIG. 9 can be saved before continue to the next step in FIG. 10.

FIG. 10 is a diagrammatic illustration of an online company proposal submission user interface of the system of FIG. 9. Shareholder proposal 910 provides Step 3 1010 for the submission of supporting documentation to the proposal. Upload window 1020 enables SHNM to upload one or more file from a hard drive or other digital storage medium by browsing the available media in a process familiar to anyone who has attached a file to an email. Similarly, window 1030 enables SHNM to upload a signed statement for the proposal. Tick virtual buttons 1040 and 1050 to acknowledge the formalities such a read and understand Securities and Exchange Commission (SEC) regulation and the online service terms and Conditions. Virtual button 1060 continues to the next step.

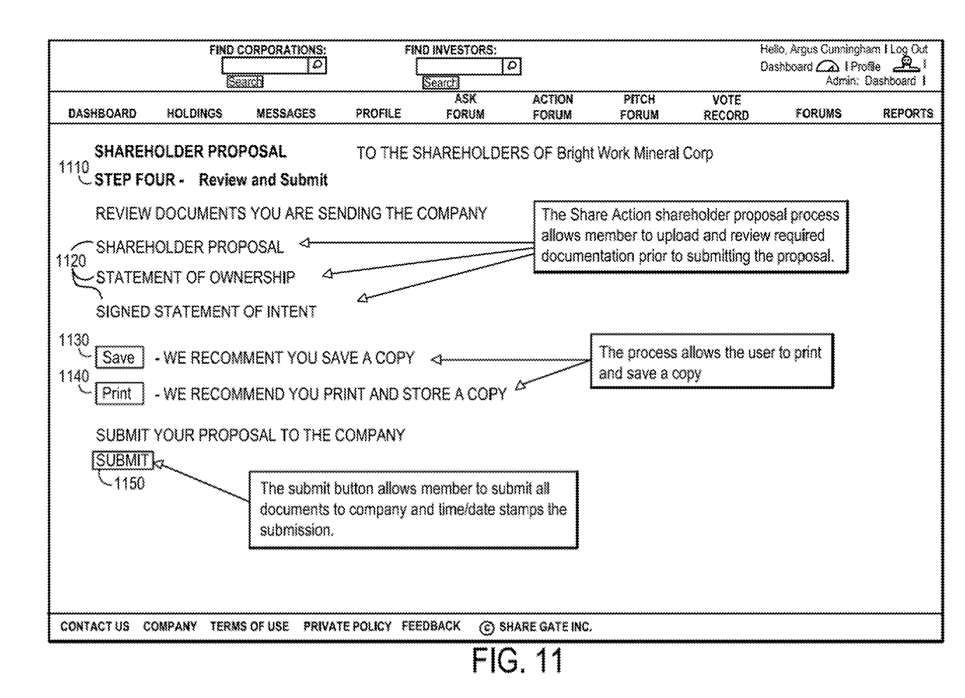

FIG. 11 is a diagrammatic illustration of an online company proposal submission review and confirmation user interface of the system of the FIG. 9. Step Four 1110 provides an opportunity for SHNM to review the material 1120 from Step 3 1010. A copy of the proposal may be save 1130, printed 1140, and submitted 1150.

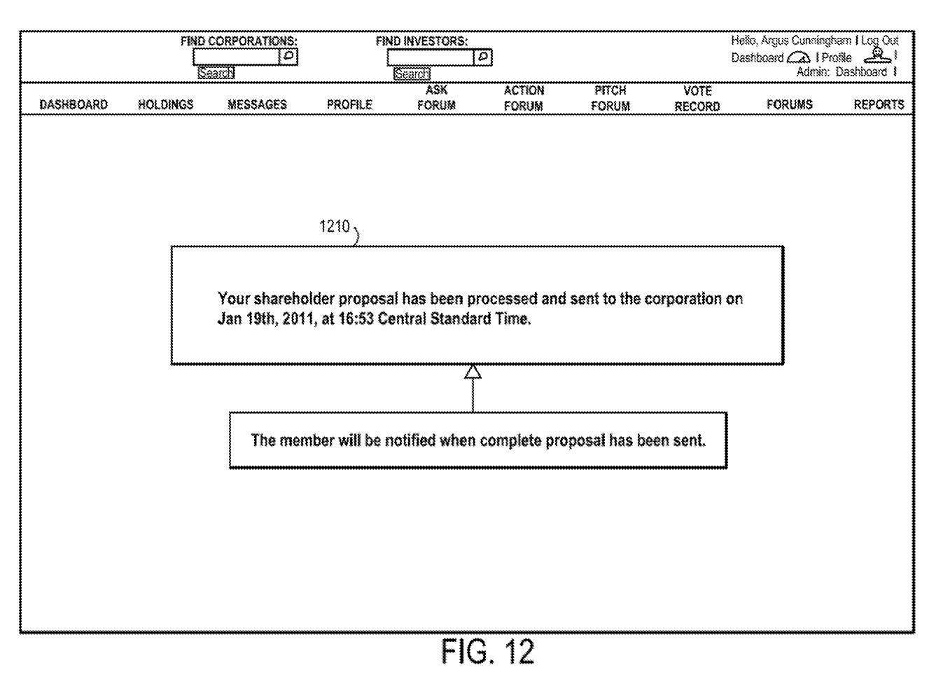

FIG. 12 is a diagrammatic illustration of an online company proposal submission completion notification of the system of FIG. 9. Successful submission notification 1210 is displayed and informs that a confirmation Email has been sent and of the ACTION ID number.

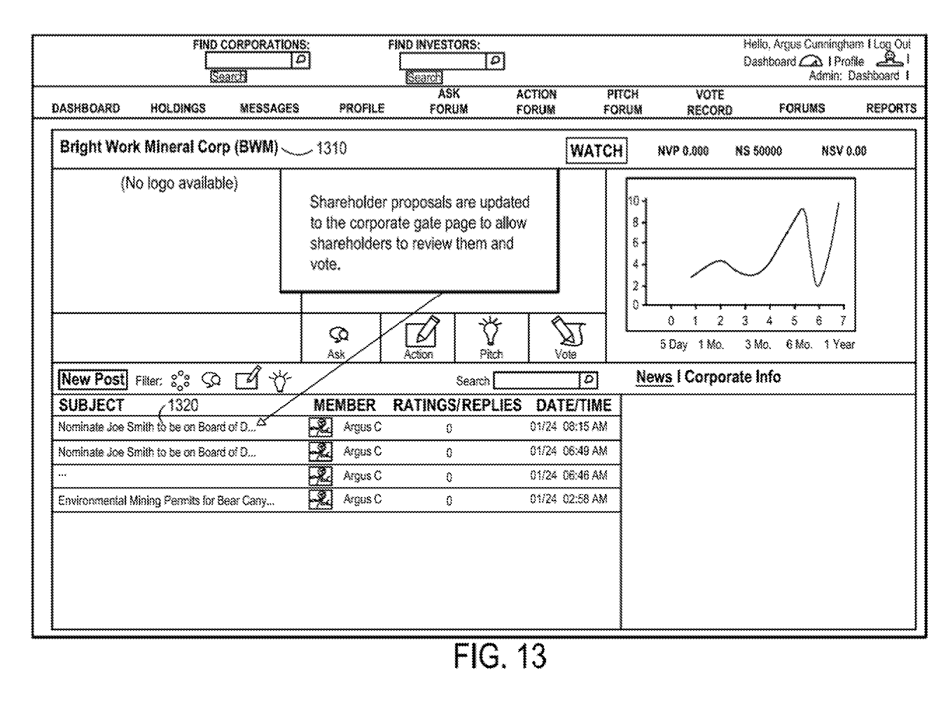

FIG. 13 is a diagrammatic illustration of an exemplary embodiment of an online company profile user interface of a system of the present disclosure, illustrating a company gate for network shareholders of a company to review and vote on proposals. Returning to company profile tab 1310 (see also FIG. 2, 210), Shareholder Proposals are updated 1320 to the corporate gate page so that other shareholders can review and vote.

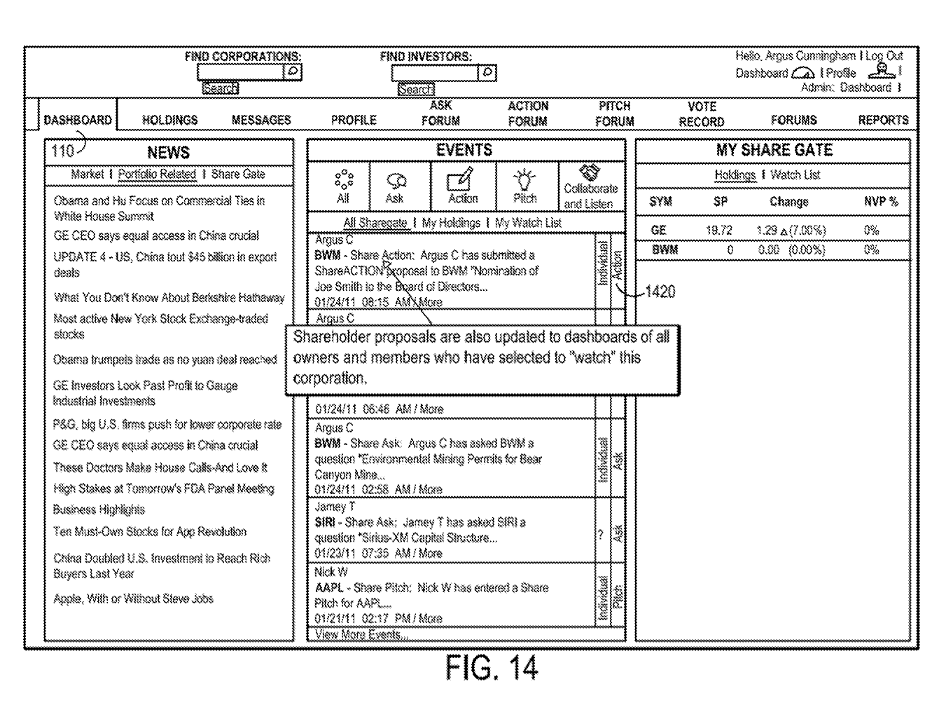

FIG. 14 is a diagrammatic illustration of an exemplary embodiment of an online member dashboard user interface, illustrating the events functions with proposal updates of a system of the present disclosure. Return to SHNM dashboard 110, Shareholder Proposals 1420 are updated to the dashboard 110 of all network owners of the company who have elected to watch the company, in addition to being updated to the company profile page 1310/210.

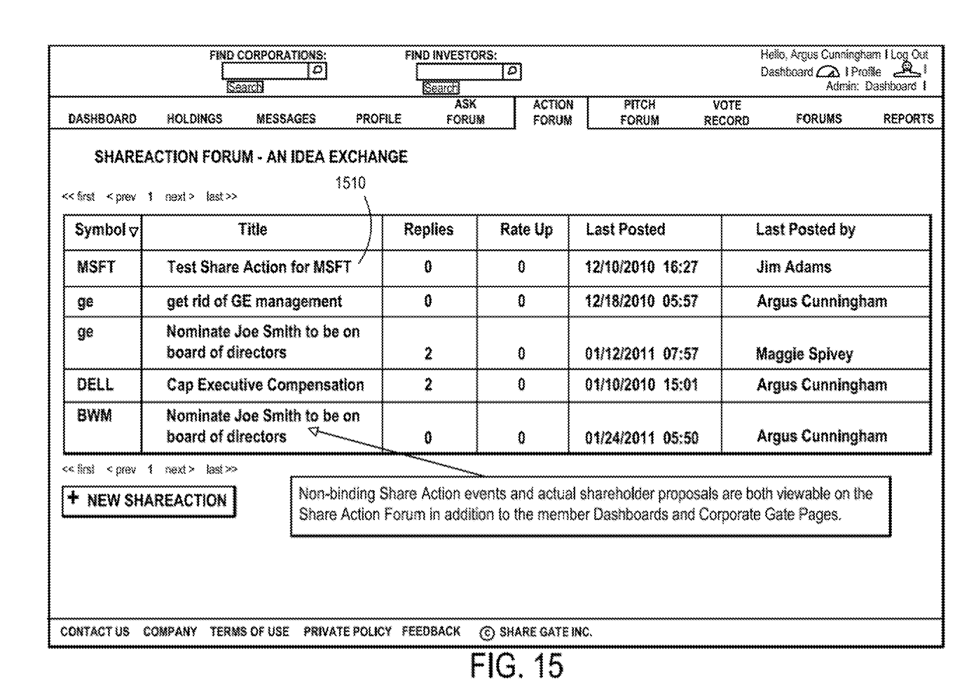

FIG. 15 is a diagrammatic illustration of an exemplary embodiment of an online member forum user interface of a system of the present disclosure. An electronic forum 1510 is provided for the owners of the company to exchange written correspondence regarding the ongoing action. Non-binding shareholder actions and actual shareholder proposals are viewable on the Share Action Forum in addition to member dashboards 110 and corporate gate pages 210.

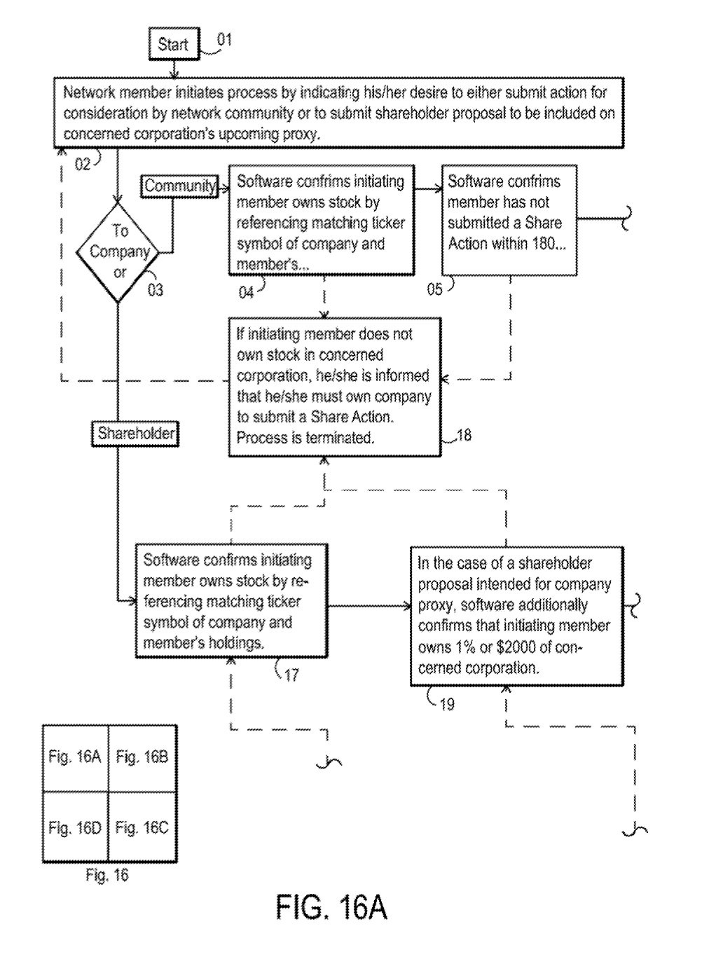

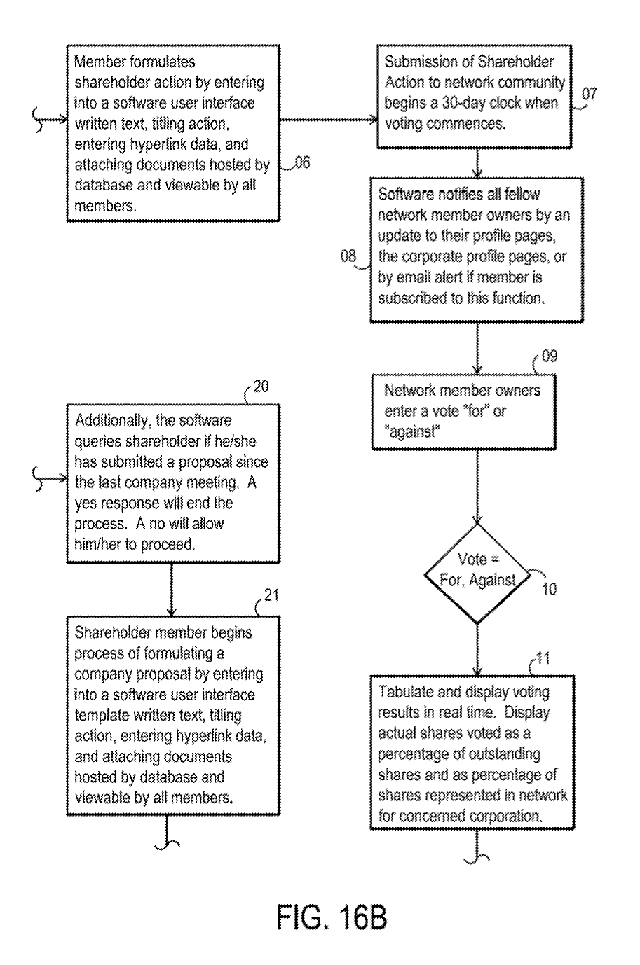

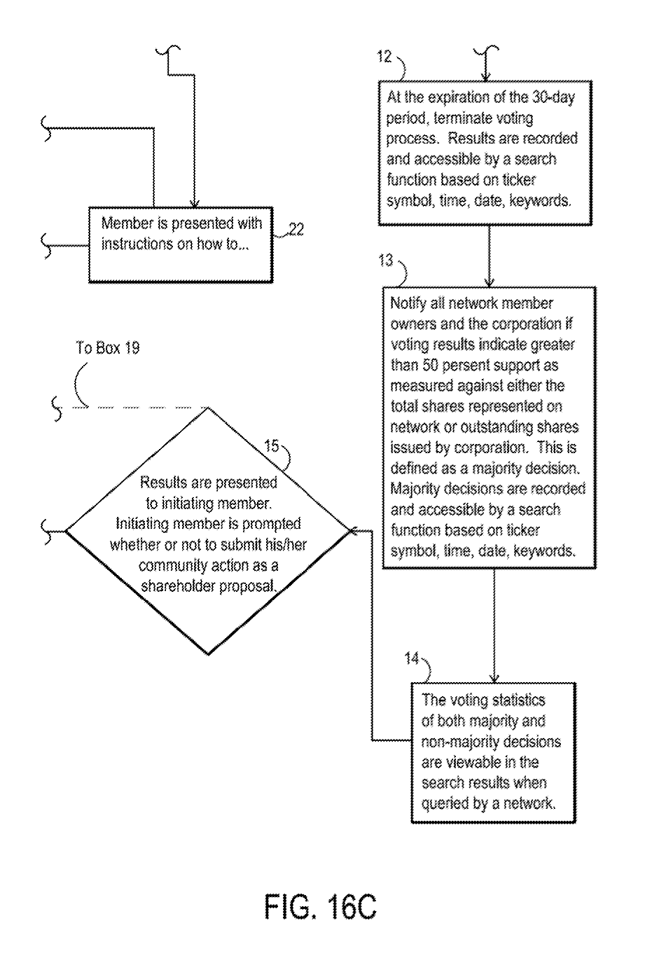

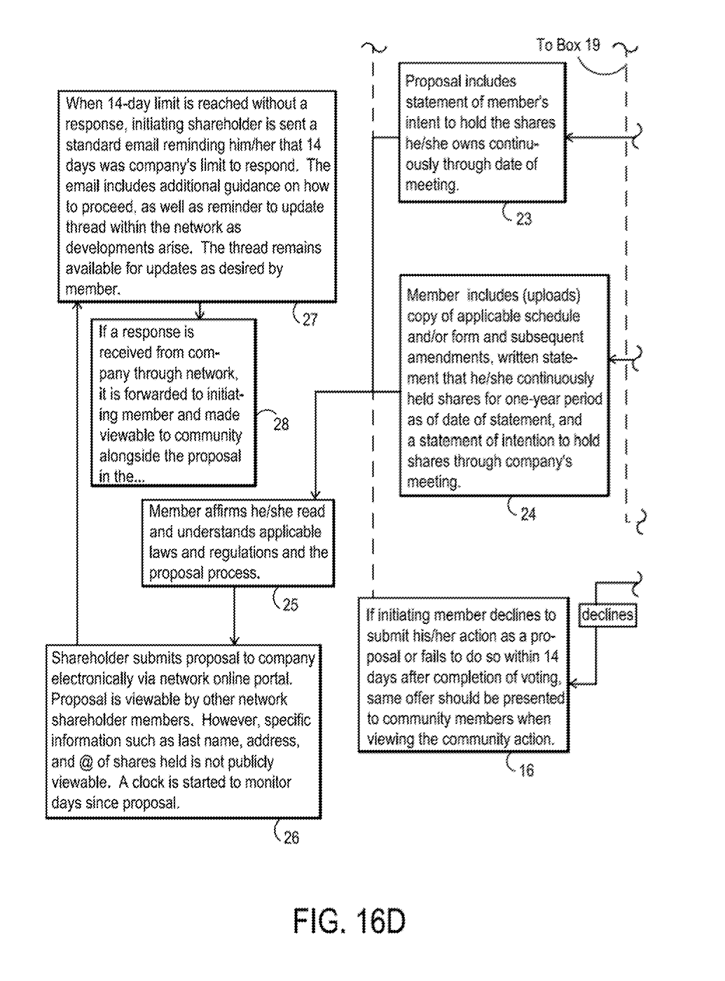

FIG. 16 is a process flow diagram of an exemplary embodiment of a method of the present disclosure. Starting in the upper left corner at “Start” 01, a network member initiates 02 the process by indicating his or her desire to either submit an action for consideration by the network community or to submit a shareholder proposal to be included on the concerned corporation's upcoming proxy 03.

If the member elects to submit an action to the the network of company shareholders 05, then the software of the present disclosure confirms that the initiating member owns the stock by referencing the matching ticker symbol of the company and the member's holdings 04. If the member does not own stock 18, the member is notified that he or she must own stock in the company before initiating and action.

The software confirms that the member has not submitted a Share Action within 180 days of initiating the current action. If the member decides NOT to submit a proposal to the company 18, then a different course is charted through the process.

Following the course of submitting an action to network shareholders, the member formulates a shareholder action by entering written text into a software user interface, titling the action, entering hyperlink data, and attaching documents hosted by the database and viewable by all members. The action so formulated is submitted to the network, specifically to network member who own shares in the company of interest. Submission of the Shareholder Action to the network community begins a 30-day clock when the voting commences 07. The software notifies all fellow network member owners by an update to their profile pages, the corporate profile pages, or by email alert if the member is subscribed to this function 08. Network member owners enter a vote “for”, “against,” or to “abstain” 09/10.

The software tabulates and display the voting results in real time 11. The display includes actual shares voted as a percentage of outstanding shares and as a percentage of the shares represented in network for the concerned corporation. At the expiration of the 30-day period, terminate the voting process. Results are recorded and accessible by a search function based on the ticker symbol, time, date, keywords, member initiating, etc. 12.

All network member owners and the corporation are notified if the voting results indicate greater than 50 percent support as measured against either the total shares represented on the network or the outstanding shares issued by the corporation 13. This is defined as a majority decision. Majority decisions are recorded and accessible by a search function based on the ticker symbol, time, date, keywords, etc. The voting statistics of both majority and non-majority decisions are viewable in the search results when queried by a network member 14.

The results are presented to the initiating member. The initiating member is prompted whether on not he would like to submit his community action as a shareholder proposal to the company 15.

If the initiating member declines to submit his action as a proposal, or fails to do so within 14 days after the completion of voting, the same offer should be presented to community members when viewing the community action 16. If another network member want so submit the action as a company proposal, the software confirms that the new initiating member owns the stock by referencing the matching ticker symbol of the company and the member's holdings 17.

If our original member does, in fact, elect to submit the action to the company as a proposal, it has already been confirmed 04 that the member owns stock in the company. However, before he or she can make a proposal to the company, in the case of a shareholder proposal intended for the company proxy, the software additionally confirms that the initiating member owns 1% or $2000 of the concerned corporation 19. Additionally, the software queries the shareholder if he or she has submitted a proposal since the last company meeting 20. A yes response will end the process. A no will allow him to proceed.

The shareholder member begins the process of formulating a company proposal by entering written text into a software user interface template, titling the action, entering hyperlink data, and attaching documents hosted by the database and viewable by all members 21.

The template includes fields for name, address, and # of shares owned fields. These fields are filled in automatically using the member's profile data and share ownership data. If the member has not previously provided his address in the profile, he will be required to enter it here. These three things (full name, address, shares owned) are required by the SEC to be made available by the company on the proxy if the shareholder proposal is included. An explanation alongside these fields (e.g., hyperlink to SEC guidance) in case the member wonders why he must provide his address. The template for entering the body of the proposal to automatically begins with the word “Whereas” and below “Resolved, shareholders request that the Board . . . ”, shareholders (standard proposal wording). An explanation is provided in the template that only those proposals cast as requests or recommendations are proper under applicable law and a hyperlink to the SEC guidance is provided.

Member is presented with instructions on how to complete the proposal 22. Specifically, he is instructed that they must submit a written statement from the record holder (usually the brokerage or bank through which he purchases shares) verifying his ownership continuously over the past year. The member uploads this statement via the network software for inclusion with the proposal when sent to the company electronically. The ability to upload supporting documentation is a feature of preferred. Additionally, the member is informed that he must submit a signed statement of intent that he will hold the shares through the date of the shareholders' meeting. Submission of the statement may be accomplished by either uploading or by electronically signing a standard network membership statement of intent.

There are three categories of shareholders that the present method is concerned with in regards to shareholder proposals. The first category, ordinary shareholders, follows the method as described above. The two other shareholder categories are registered shareholders (those who purchase shares directly from the company) or large shareholders who are required to file paperwork to the Securities Exchange Commission (SEC). The method herein described assumes that the shareholder initiating the proposal is an ordinary shareholder and presents the appropriate process by default. To accommodate the other two categories, specific embodiments of the software of the present disclosure include a brief question at the bottom of the template asking, “Are you a registered shareholder or have you filed a Schedule 13D, Schedule 13G, Form 3, Form 4, and/or Form 5, or amendments to these documents or updated forms? If so, click here. An explanation is provided alongside this question for those unsure or just curious. If the member clicks on the link, they are asked which category they fall under and the method will proceed as follows.

Proposal includes a statement of the member's intent to hold the shares they own continuously through the date of the meeting 23, or the member includes (uploads) a copy of applicable schedule and/or form and any subsequent amendments, a written statement that they continuously held the shares for the one-year period as of the date of the statement, and a statement of intention to hold the shares through the company's meeting 24. In both cases, member affirms the he read and understands applicable laws and regulations and the proposal process 25. Prior to submittal, the shareholder is presented with the relevant SEC rules for shareholder proposals, and he must affirm that he has read and understands the process.

Shareholder submits the proposal to the company electronically via the network online portal 26. The proposal is viewable by other network shareholder members, however, specific information such as last name, address, and # of shares held is not publicly viewable. Along with the proposal, specific embodiments provide a request from the shareholder that all correspondence be sent to them via the network. The initiating shareholder may acknowledge this preference prior to submittal. A clock is started to monitor the days since the proposal was submitted.

When the 14 day limit is reached without a response, the initiating shareholder is sent a standard email reminding him that 14 days was the companies limit to respond. In specific embodiments, the email includes additional guidance on how to proceed, as well as a reminder to update the thread within the network as developments arise. Along with the email, the network software notifies the initiating member that he now has 14 days to respond to the company or correct deficiencies in his proposal in cases where the company intends to exclude the proposal from the proxy. This step generates a standard message to the member on what to expect going forward. The thread remains available for updates as desired by the member. The thread remains available for updates as desired by the member and any other responses from the company will be included.

If a response is received from the company through the network, it is forwarded to the initiating member and made viewable to the community alongside the proposal in the thread.

Accordingly, the present disclosure describes a shareholder voting action software application, system and method utilizing at least one server having an internet accessible digital database containing the applicable personal details regarding a plurality of shareholder network members, a computer component provides (1) a login process that matches and verifies that shareholder to the database server, (2) a memory store to, among other things, identify members and facilitate the voting action initiation by any member who is an owner or owner representative of the involved corporation identified in the process.

The verification process that utilizes name and password previously established to access the database and utilize the software that verifies holdings ownership based on data aggregation communication. This occurs by process software electronically communicating with, for example, a supported brokerage to access holdings information from the concerned individual's brokerage account. Individual stock data is continually be verified electronically on a daily basis via the internet. For institutional members, ownership verification will be sourced from electronically accessible. S.E.C. Form 13F filings, other relevant reporting documentation, or manual entry by an organization representative. The time of data entrance is recorded by the database.

The software application of the present disclosure identifies all network owners of the concerned stock identified by the stock ticker symbol. The software automatically accomplishes this by referencing ticker symbols appearing in members' holdings data. Only owners of the stock are allowed the option of initiating action and entering the data for shareholder action, source links, and the option to advance the action. This permission is enabled by referencing account holdings data.

A software application on the server, for example, facilitates an electronic notification system that notifies all other registered owners of said corporation, and presents voting options to those members identified by the database. Another software application provides means for a plurality of owner shareholders to participate in the vote, tabulate, and display real time results. Preferred embodiments utilize previously input data entered into the member accessible data base, searches for those members in the data base and presents only the members who own the stock, with voting options. Shareholder owners select vote options of “for, against, or “abstain.” Supporting information submitted by the initiator and ongoing voting results are displayed. Shareholders are prevented from voting twice by updating database with vote record. Initiation of the action is recorded and a clock starts counting down to the expiration of the voting period. That is, a predetermined deadline is established for voting. At a predetermined time limit the action is terminated and recorded.

In a preferred embodiment, the software application calculates vote results and displays sum of voting results in real time. The sum of votes for each option (for, against, abstain) are displayed along with the votes as a percentage of the outstanding shares with available votes. The vote percentage is calculate by, for example, taking the sum of each vote option results divided by the amount of outstanding shares then divided by 100 and rounded at the fourth decimal. The software application records the voting action and establishes a record. Specific embodiments provide a search function to electronically access previous share holder actions.

The software application allows voters to retract or change their vote at any anytime during the process before the two outcomes are reached and prevents multiple votes by recognizing that a vote has already been submitted by an initiating member. An historical record of all shareholder actions is kept and accessible through a search function.

The action fails if, upon expiration of the voting period the voting result does not exceed 50%. The action is passed if the voting result exceeds 50%. All network members who own the stock are electronically notified. These members are notified via their dashboard page, by private messaging, or by email if subscribed to this function. Notification distribution is based on holdings data information previously acquired.

An action that has passed may be converted into a company proposal and may be selectively submitted to the company as a shareholder proposal. In certain circumstances, a shareholder owner network member must be qualified to initiate an action and, in particular, to submit a company proposal. For example, the SHNM must own a minimum percentage of outstanding shares on the company to qualify to submit a proposal. A software application of the present disclosure automatically verifies from the database source data and calculates the outstanding shares and member input data to calculate the sum of all member shares. Network and member ownership percentages are displayed on the network member share holder action webpage informing the member of available network voting power (NVP) concerning the subject corporation. Additionally, the voting power available to each member is calculated and displayed as a percentage. This calculation is performed using accessible data source from corporate filings stating the amount of shares issued by the concerned corporation. The outstanding shares data is sourced, in specific embodiments, from an exterior internet based streaming data source where source data is retrieved from corporate filings. The amount of shares owned by the concerned member is divided by the outstanding shares issues multiplied by 100 and displayed as a percentage. In specific embodiments, the sum network voting power for a particular stock will be visible by all network members.

The method and software application of the present disclosure further enable the participant to assemble and title a United State Securities Exchange Commission (S.E.C) compliant shareholder proposal by presenting an information entry template and regulatory guidance selection options. An information entry template allows a initiating member to enter a title, supporting data, and reference hyperlinks. The proposal time and date is recorded. Notification updates and predetermined voting deadline expiration times are provided.

The initiating member is presented regulatory guidance concerning compliance measure related to minimum ownership requirements, time tables, and process benchmarks for completion. The software application presents the initiating member with selections boxes where the member must select certain compliance assertions to facilitate process completion. The software application records the initiation date and time and originates and disseminates specific notifications based on regulatory time guidelines sourced from S.E.C shareholder proposals regulations.

In addition to the foregoing embodiments, the present disclosure provides system that includes without limitation a website hosted on at least one server connected to the World Wide Web and a network of shareholder website members, wherein at least one server hosting the website comprises a processor and a computer readable memory unit coupled to the processor, said memory unit containing program code configured to be executed by the processor to implement a method for conducting a shareholder action among shareholders of a company in an online network.

In specific embodiments, the methods of the present disclosure are executed at least in part with the use of programs stored on machine readable medium to operate computers and devices according to the principles of the present disclosure. Machine readable media include, but are not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMs, DRAMs, SRAMs, firmware, programmable logic, etc.), server hard drives, thumb drives, also called memory sticks and the like. Furthermore, machine readable media include transmission media (network transmission line, wireless transmission media, signals propagating through space, radio waves, infrared signals, etc.) and server memories. Moreover, machine readable media includes many other types of memory too numerous for practical listing herein, existing and future types of media incorporating similar functionally as incorporate in the foregoing exemplary types of machine readable media, and any combinations thereof. The programs and applications stored on the machine readable media in turn include one or more machine executable instructions which are read by the various devices and executed. Each of these instructions causes the executing device to perform the functions coded or otherwise documented in it. Of course, the programs can take many different forms such as applications, operating systems, Perl scripts, JAVA applets, C programs, compliable (or compiled) programs, interpretable (or interpreted) programs, natural language programs, assembly language programs, higher order programs; embedded programs, and many other existing and future forms which provide similar functionality as the foregoing examples, and any combinations thereof.

Additionally, the present disclosure contemplates the present methods, system and software applications adapted for mobile devices such as smart phones and tablet computers that utilize software “apps.”

Many modifications and other embodiments of the method and system described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for conducting a shareholder action among shareholders of a company in an online network, the method comprising:
a. providing a website hosted on at least one server connected to the World Wide Web for communications among network members;
b. initiating a shareholder action for network members who own shares in the company;
c. communicating the action to said network member shareholders via the World Wide Web;
d. receiving votes on the action from network member shareholders via the World Wide Web;
e. tallying the received votes to determine a result; and
f. communicating the result to the network member shareholders via the website.

2. The method of claim 1, further comprising converting the shareholder action into a company proposal; and submitting the proposal to the company for consideration.

3. The method of claim 2, further comprising a deadline by which network shareholders must decide whether to convert the action into a company proposal.

4. The method of claim 2, further comprising automatically determining that a shareholder member is qualified to submit a company proposal.

5. The method of claim 1, wherein the steps of communicating the action and receiving votes further comprise posting the action on the web site and providing a vote recorder on the web site.

6. The method of claim 1, wherein the website provides a forum for network shareholders to comment on and give other feedback concerning the action.

7. The method of claim 1, further comprising a deadline after which votes will not be received.

8. A system to conduct one or more shareholder actions among shareholders of a company in an online network, the system comprising a website hosted on at least one server connected to the World Wide Web and a network of shareholder website members, wherein at least one server hosting the website comprises a processor and a computer readable memory unit coupled to the processor, said memory unit containing program code configured to be executed by the processor to implement a method for conducting a shareholder action among shareholders of a company in an online network, the method comprising:
a. providing a website hosted on at least one server connected to the World Wide Web for communications among network members;
b. initiating a shareholder action for network members who own shares in the company;
c. communicating the action to said network member shareholders via the World Wide Web;
d. receiving votes on the action from network member shareholders via the World Wide Web;
e. tallying the votes to determine a result; and
f. communicating the result to the network member shareholders via the website.

9. The system of claim 9, wherein the method further comprises converting the shareholder action into a company proposal; and submitting the proposal to the company for consideration.

10. A method for initiating a company proposal by at least one shareholder of a company in an online network, the method comprising:
passing a shareholder action concerning the company via on online network shareholder member vote;
converting the passed shareholder action into a company proposal; and
submitting the proposal to the company via an online submission.

11. The method of claim 10, further comprising automatically determining that a shareholder member is qualified to submit a company proposal.

12. The method of claim 10, wherein the step of passing a shareholder action further comprises:
a. providing a website hosted on at least one server connected to the World Wide Web for communications among network members;
b. initiating a shareholder action for network members who own shares in the company;
c. communicating the action to said network member shareholders via the World Wide Web;
d. receiving votes on the action from network member shareholders via the World Wide Web;
e. tallying the votes to determine a result; and
f. communicating the result to the network member shareholders via the website.

13. The method of claim 10, further comprising a deadline by which network shareholders must decide whether to convert the action into a company proposal.

14. The method of claim 10, wherein the company proposal is compliant with S.E.C. regulations.

15. The method of claim 10, wherein a shareholder network member is automatically verified to be eligible to submit a company proposal.
